(19) United States
(12) Patent Application Publication
(10) Pub. No.: US 2011/0006662 A1
(43) Pub. Date: Jan. 13, 2011

(54) Display Apparatus and Method for Manufacturing the Same

(76) Inventors: Young Ho Kwon, Yongin-si (KR); Hyung Sup Lee, Suown-si (KR); Jae Young Byun, Seoul (KR); Hyuk Lim, Seoul (KR); Young Sam Yu, Seoul (KR); Dong Gun Oh, Osan-si (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/831,840

(22) Filed: Jul. 7, 2010

(30) Foreign Application Priority Data
Jul. 7, 2009 (KR) 10-2009-0061738

(51) Int. Cl. H01J 5/00; H01J 9/24

(52) U.S. Cl. 313/317; 445/23

(57) ABSTRACT

An electro-optic device is inserted and mounted into the internal space of the multi-layered member. Herein, the multi-layered member includes the first and second plates disposed to be separated from and facing each other. At least one of the first and second plates is manufactured with a transparent material to transmit light that is generated from the electro-optic device. Among the first and second plates of the multi-layered member, a plate corresponding to the size of a display apparatus to be manufactured is used. Consequently, by inserting and mounting a small electro-optic device into the internal space of the multi-layered member that is manufactured in a large area, a large-area display apparatus can be manufactured even without using a large-size deposition apparatus and a large-area substrate. Accordingly, the manufacturing cost of the large-area display apparatus can be saved.

### CROSS-REFERENCE TO RELATED APPLICATION

This application claims priority to Korean Patent Application No. 10-2009-0061738 filed on Jul. 7, 2009 and all the benefits accruing therefrom under 35 U.S.C. §119, the contents of which are incorporated by reference in their entirety.

### BACKGROUND

The present disclosure relates to a display apparatus and a method for manufacturing the same, and more particularly, to a display apparatus wherein an electro-optic device is inserted and mounted into the internal space of a multi-layered member and a method for manufacturing the same.

Recently, with the rapid advance of information communication technologies, flat panel displays are getting the spotlight as display devices. The representative examples of the flat panel display include a Liquid Crystal Display (LCD), a Plasma Display Panel (PDP) and an Organic Light Emitting Device (OLED).

The OLED out of the above examples are used for manufacturing high-quality displays due to its wide viewing angle and a fast response time. Attempts to apply the OLED for displays and lightings for buildings are also actively being made. For example, the OLED is manufactured to have a large area and installed at the interiors/exteriors of buildings. The OLED generally includes a substrate, a lower electrode formed on the substrate, an organic material layer formed on the lower electrode, and an upper electrode formed on the organic material layer. In order to manufacture a large area OLED, e.g., larger than the 3.5 generation, a large area substrate corresponding thereto should be transferred into a deposition apparatus. Therefore, a large size deposition apparatus for processing the large area substrate is required, which results in an increase of manufacturing costs and technical difficulties in manufacturing the large area OLEDs. Moreover, since a very thin glass substrate is used for the OLED, the OLED may be easily damaged when employed in the displays or lightings at interior/exterior of buildings.

### SUMMARY

The present disclosure provides a display apparatus and a method for manufacturing the same, in which an electro-optic device is inserted and mounted into the internal space of a multi-layered member that includes first and second plates disposed to be separated from and facing each other, wherein at least one of the first and second plates is manufactured with a transparent material capable of transmitting light.

In accordance with an exemplary embodiment, a display device includes: first and second plates spaced apart from and facing each other; a coupling member around edges of the first and second plates, the coupling member configured to fix the first and second plates; and an electro-optic device having one side on an inner side of one of the first and second plates between the first and second plates and another side on an inner side of the other of the first and second plates.

In accordance with another exemplary embodiment, a display device includes: first and second plates spaced apart from and facing each other; a concave portion in an inner side of one of the first and second plates; a coupling member around edges of the first and second plates to fix the first and second plates; and an electro-optic device in the concave portion.

The display device may further include one or more of a transparent filling material, vacuum, and an inactive gas between the first and second plates, wherein the transparent filling material comprises at least one of a transparent tape and a transparent organic material.

The display device may further include an electrode interconnection disposed on the inner side of at least one of the first and second plates to supply power to the electro-optic device.

The electrode interconnection may include a transparent conductive material.

At least one of the first and second plates may include a transparent material, and the transparent material may be disposed in a light-emitting direction, the light being emitted from the electro-optic device.

The electro-optic device may include an organic light emitting diode (OLED).

The display device may further include a spacer spacing the first and second plates by a predetermined distance in a region between the first and second plates, in a location other than that of the electro-optic device.

In accordance with yet another exemplary embodiment, a method of manufacturing a display device includes: disposing first and second plates to be spaced apart from each other; and attaching one side of an electro-optic device to an inner side of one of the first and second plates, and attaching another side of the electro-optic device to an inner side of the other one of the first and second plates.

In accordance with still another exemplary embodiment, a method of manufacturing a display device includes: preparing first and second plates and a concave portion in an inner side of one of the first and second plates; mounting an electro-optic device in the concave portion; and spacing the other one of the first and second plates to face the one plate where the electro-optic device is mounted.

The method may further include filling a space between the first and second plates with at least one of a transparent filling material, vacuum, and an inactive gas.

The method may further include forming an electrode interconnection on the inner side of at least one of the first and second plates, the electrode interconnection supplying power to the electro-optic device.

The method may further include mounting a spacer between the first and second plates in a location other than that of the electro-optic device, the spacer spacing the first and second plates by a predetermined distance.

### BRIEF DESCRIPTION OF THE DRAWINGS

Exemplary embodiments can be understood in more detail from the following description taken in conjunction with the accompanying drawings, in which:

FIG. 1 is a view illustrating a display apparatus according to an exemplary embodiment;

FIG. 2 is a plan view illustrating a display apparatus according to an exemplary embodiment;

FIG. 3 is a cross-sectional view illustrating a display apparatus according to an exemplary embodiment;

FIG. 4 is a cross-sectional view illustrating an electro-optic device according an exemplary embodiment;

FIG. 5 is a view illustrating a display apparatus according to an exemplary embodiment;

FIG. 6 is a plan view illustrating a display apparatus according to an exemplary embodiment;

FIG. 7 is a cross-sectional view illustrating a display apparatus according to an exemplary embodiment;

FIG. 8 is a cross-sectional view illustrating a display apparatus according a modified embodiment;

FIG. 9 is a cross-sectional view illustrating an electro-optic device according to an exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

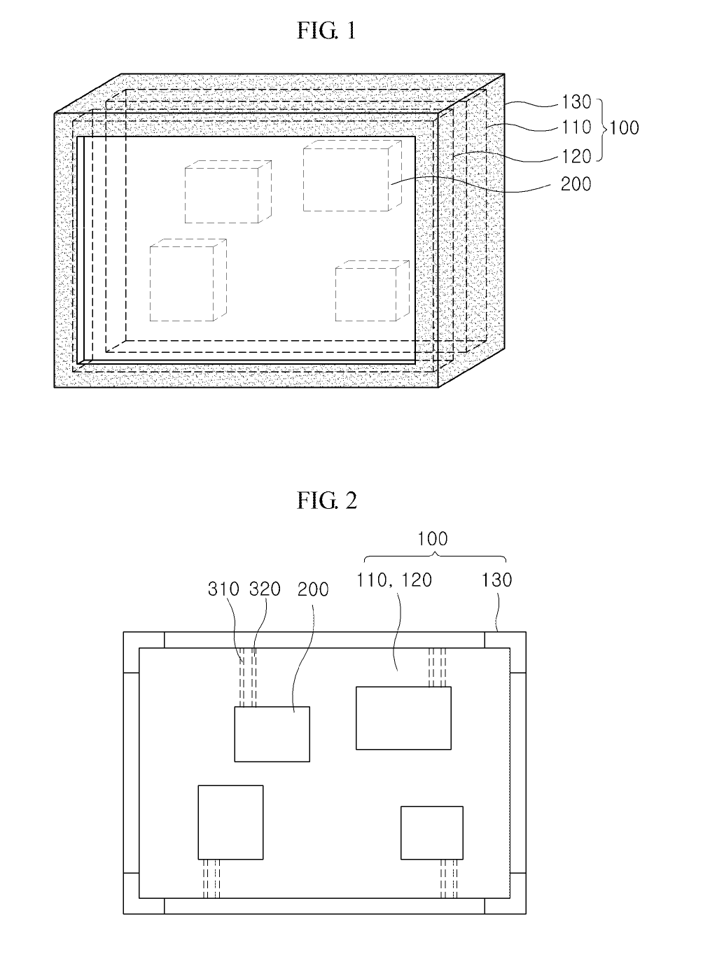

FIG. 1 is a view illustrating a display apparatus according to an exemplary embodiment. FIG. 2 is a plan view illustrating a display apparatus according to an exemplary embodiment. FIG. 3 is a cross-sectional view illustrating a display apparatus according to an exemplary embodiment.

In a display apparatus according to an exemplary embodiment at least one electro-optic device 200 is inserted and mounted into the internal space of a multi-layered member 100. The display apparatus, as illustrated in FIGS. 1 through 3, includes the multi-layered member 100 having an internal space, at least one electro-optic device 200 that is inserted and mounted into the internal space of the multi-layered member 100, a first and second interconnections 310 and 320 that are formed at the inner surface of the multi-layered member 100 to apply a power source to the electro-optic device 200, and a junction member 400 that joins the electro-optic device 200 to the inside of the multi-layered member 100.

The multi-layered member 100 includes first and second plates 110 and 120 that are disposed to be separated from each other and facing each other, and a coupling member 130 that is disposed at the edge regions of the first and second plates 110 and 120 to fix the first and second plates 110 and 120. In this way, the first and second plates 110 and 120 are disposed to be separated from each other and facing each other, and thus the internal space of the multi-layered member 100 is provided. The electro-optic device 200 is inserted and mounted into the internal space of the multi-layered member 100, i.e., the space between the separated first and second plates 110 and 120. Herein, the multi-layered member 100 may be manufactured to be in correspondence with the size of a display apparatus for manufacturing. For manufacturing a large-area display apparatus to be disposed at the interior/exterior of a building, in an exemplary embodiment, the first and second plates 110 and 120 having a size corresponding to the large-area display apparatus are prepared, and the at least one electro-optic device 200 is inserted and mounted between the first and second plates 110 and 120. Herein, at least one of the first and second plates 110 and 120 may be manufactured with a transparent material. That is, among the first and second plates 110 and 120, at least one plate that is disposed in the output direction of light generated from the electro-optic device 200 is manufactured with a transparent material. In an exemplary embodiment, the first and second plates 110 and 120 are manufactured with a light-transmitting window. In the above-described, the first and second plates 110 and 120 have been manufactured in a tetragonal shape, but they are not limited thereto and may be manufactured in various shapes. At this point, vacuum treatment may be performed for the internal space of the multi-layered member 100, i.e., the space between the separated first and second plates 110 and 120. However, an exemplary embodiment is not limited thereto, and the space between the separated first and second plates 110 and 120 may be filled with an inactive gas.

In an exemplary embodiment, it has been described above that the first and second plates 110 and 120 of the multi-layered member 100 are separated. However, an exemplary embodiment is not limited thereto, and an integrated plate may be used which has an internal space where the electro-optic device 200 may be inserted and mounted.

In this way, the display apparatus which applies the multi-layered member 100 having the internal space may be applied to various multi-layered members such as a multi-layered member used in the interior/exterior of a building, a multi-layered member for window, a multi-layered member for door, a multi-layered member for partition, a multi-layered member for tempered glass, a multi-layered member for safety glass or a multi-layered member for vehicle. In an exemplary embodiment, moreover, the display apparatus with the electro-optic device 200 mounted into the transparent multi-layered member 100 has been described above, but it is not limited thereto and may be used as a lighting device. That is, the display apparatus outputs light, which is generated from the electro-optic device 200, to the transparent multi-layered member 100 and thus may be used as a lighting device for radiating light.

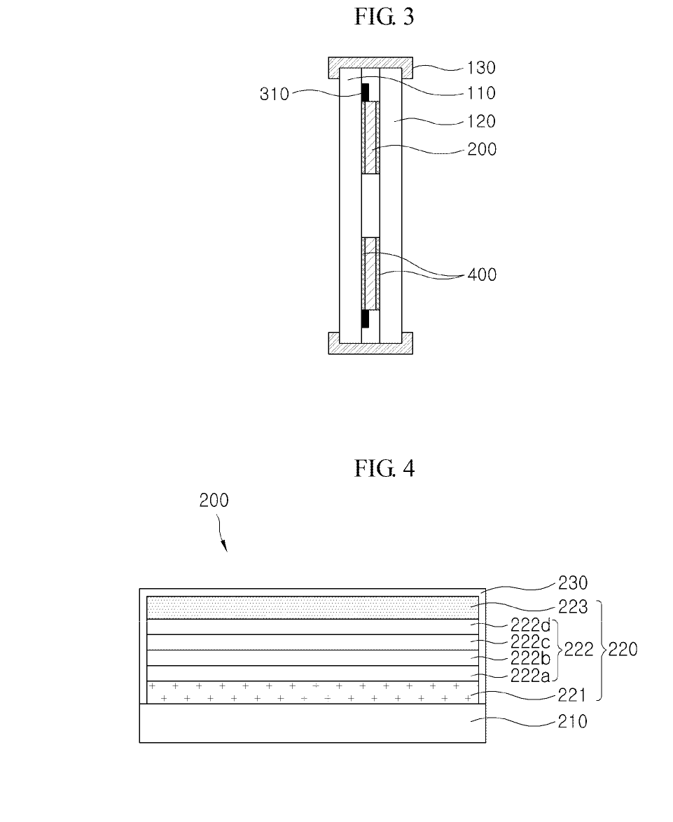

FIG. 4 is a cross-sectional view illustrating an electro-optic device according an exemplary embodiment.

In an exemplary embodiment, an OLED is used as the electro-optic device 200. Herein, an OLED which emits light in one direction is used. However, an exemplary embodiment is not limited thereto, and an OLED which emits light in both directions may be used. Moreover, an exemplary embodiment is not limited thereto, and various electro-optic devices 200 may be used.

Referring to FIG. 4, the electro-optic device 200 includes a substrate 210, an organic light emitting layer 220 that is formed on the substrate 210 and emits light, and an encapsulation unit 230 that is disposed to cover the organic light emitting layer 220. Herein, the organic light emitting layer 220 includes a lower electrode 221 formed on the substrate 210, an organic material layer 222 formed on the lower electrode 221, and an upper electrode 223 formed on the organic material layer 222.

The substrate 210 is manufactured with a transparent material so that light generated from the organic material layer 222 may be outputted to the outside through the substrate 210. In an exemplary embodiment, a glass or a plastic is used as the substrate 210. Furthermore, the lower electrode 221 used as an anode is formed on the substrate 210. Herein, the lower electrode 221 is manufactured with a transparent conductive material. That is, the lower electrode 221 is formed of any one of Indium Tin Oxide (ITO), Indium Zinc Oxide (IZO), Zinc Oxide (ZnO) and In₂O₃. The lower electrode 221 is formed on the substrate 210 through a sputtering process, but it is not limited thereto. The lower electrode 221 may be formed by applying various deposition processes other than the sputtering process according to the transparent conductive material used for the lower electrode 221.

The organic material layer 222 is formed on the lower electrode 221, and includes a hole injecting layer 222a, a hole transport layer 222b, a light emitting layer 222c and an electron transport layer 222d. In the organic material layer 222, the hole injecting layer 222a, the hole transport layer 222b, the light emitting layer 222c and the electron transport layer 222d may be sequentially stacked. That is, the hole injecting layer 222a made of an organic material such as CuPc, 2-TNATA and MTDATA is formed on the lower electrode 221. Subsequently, the hole transport layer 222b made of a material which may efficiently transfer holes, such as NPB and TPD, is formed on the hole injecting layer 222a. The light emitting layer 222c is formed on the hole transport layer 222b. The light emitting layer 222c using a material having excellent light-transmitting characteristic may include one of a green light emitting layer including Alq3:C545T, a blue light emitting layer including DPVBi, a red light emitting layer including CBP:Ir (acac) or combinations thereof. Subsequently, the electron transport layer 222d made of an organic material such as Alq3 and Bebq2 is formed on the light emitting layer 222c. Herein, the organic material layer 222 is deposited in a thermal evaporation process. Furthermore, an organic material for the organic material 222 may be substituted according to requirements.

The upper electrode 223 according to an exemplary embodiment used as a cathode is deposed on the electron transport layer 222d of the organic material layer 222. The organic light emitting device according to an exemplary embodiment is of a rear light emission type, and metals such as LiF—Al, Mg:Ag and Ca—Ag are used to form the upper electrode 223 to reflect light. The present invention is not limited thereto, and the upper electrode 223 may be formed to a thickness of approximately several μm or less to transmit light by using transparent conductive materials such as ITO, IZO, ZnO and In₂O₃ or metal materials such as LiF—Al, Mg:Ag and Ca—Ag. The upper electrode 223 is deposited on the organic material layer 222 through a sputtering process. The present invention is not limited thereto, and the upper electrode 223 may be formed through various deposition processes such as sputtering and electron beam deposition, depending on the types of materials used for forming the upper electrode 223.

The encapsulation unit 230 protects the organic light emitting layer 220 disposed on the substrate 210. In an exemplary embodiment, the encapsulation unit 230 may be formed from a thin transparent film. The present invention is not limited thereto, and the encapsulation unit 230 may be formed from a glass or metal can. In this case, although not illustrated in the drawings, the substrate 210 and the encapsulation unit 230 disposed on the upper electrode 223 are joined together by coating a sealant onto the edge region of the substrate 210 and positioning the encapsulation unit 230 onto the upper substrate 223.

In an exemplary embodiment, the electro-optic device 200 is formed to have a tetragonal section. The present invention is not limited thereto, and the electro-optic device 200 may be formed to have various shapes. For example, the electro-optic device 200 may be formed to have display shapes desired by users, such as the shape of images or characters. Also, a plurality of electro-optic devices 200 may be formed to have different sizes and shapes. Also, as illustrated in FIGS. 1 and 2, the electro-optic devices 200 may be disorderly disposed at irregular intervals so that they can be displayed at locations desired by users. The present invention is not limited thereto, and the electro-optic devices 200 may be disposed to maintain a predetermined interval.

One end of the first/second electrode interconnection 310/320 is connected to an external power source, and the other end thereof is connected to the electro-optic device 200 to supply power to the electro-optic device 200. The first/second electrode interconnection 310/320 is formed on the surface of at least one of the first and second plates 110 and 120 of the multi-layered member 100. In an exemplary embodiment, the first and second electrode interconnections 310/320 are formed on the rear surface of the first plate 110, to which the present invention is not limited. For example, the first and second electrode interconnections 310 and 320 may be formed on the rear surface of the second plate 120, or may be formed respectively on the first and second plates 110 and 120. Also, the first and second electrode interconnections 310 and 320 are connected to the lower electrode 221 and the upper electrode 223 of the electro-optic device 200. For example, the first electrode interconnection 310 is connected to the lower electrode 221 of the electro-optic device 200, and the second electrode interconnection 320 is connected to the upper electrode 223. The connection in the opposite way may also be possible. In this case, the first and second electrode interconnections 310 and 320 may be connected respectively to a plurality of electro-optic devices 200 so that the electro-optic devices 200 operate separately. The first and second electrode interconnections 310 and 320 are formed of one of ITO, IZO, ZnO and In₂O₃ (i.e., transparent conductive materials) through a sputtering process. The present invention is not limited thereto, and the first and second electrode interconnections 310 and 320 may be formed through various processes other than a sputtering process, depending on the types of transparent conductive materials. In an exemplary embodiment, the first and second electrode interconnections 310 and 320 are formed using a transparent conductive material. Also, the first and second electrode interconnections 310 and 320 may be formed using a metal with a good electric conductivity. Also, the metal may be formed to a thickness of approximately several μm or less to form the first and second electrode interconnections 310 and 320 with transparent properties.

The junction member 400 serves to join the electro-optic device 200 to the inner surface of the multi-layered member 100. That is, the junction member 400 is disposed between the first plate 110 and the substrate 210 of the electro-optic device 200 and between the second plate 120 and the upper electrode 223 of the electro-optic device 200 to join the electro-optic device 200 to the inner surface of the multi-layered member 100. In an exemplary embodiment, the junction member 400 is formed of a double-faced adhesive high-polymer film. In this case, a transparent high-polymer film may be used to form the junction member 400 so that the light generated by the electro-optic device 200 can be emitted to the outside through the junction member 400. The present invention is not limited thereto, and various units may be used to join the electro-optic device 200 between the first and second plates 110 and 120.

In this way, the electro-optic device 200 is installed into the internal space of the multi-layered member 100, thereby making it possible to easily manufacture a large-area display apparatus. Also, since the electro-optic device 200 is installed in the transparent multi-layered member 100, the display apparatus may be used as a lighting device. Also, the display apparatus may be used as a window device. That is, the first and second plates 110 and 120 are formed using a transparent material, and a transparent electro-optic device (e.g., a transparent organic light emitting device) is installed between the first plate 110 and the second plate 120. Thus, when the organic light emitting device operates, the display apparatus is used as a display device; and when the organic light emitting device does not operate, the display apparatus is used as a window device.

Hereinafter, a method of manufacturing a display apparatus according to an exemplary embodiment will be described with reference to FIGS. 1 through 4.

A first plate 110 is prepared and first and second electrode interconnections 310 and 320 are formed on the rear surface of the first plate 110. Although not illustrated in the drawings, the first plate 110 includes: a light emitting region where an electro-optic device 200 is to be adhered to emit light; and an interconnection region where the first and second electrode interconnections 310 and 320 are to be formed. The first and second electrode interconnections 310 and 320 are formed to be electrically connected to an electro-optic device 200 that will be installed in the light emitting region of the first plate 110. The first and second electrode interconnections 310 and 320 are formed of transparent conductive materials such as ITO, IZO, ZnO and In₂O₃. A junction member 400 is adhered to the light emitting region of the first plate 110 to which the electro-optic device 200 is to be adhered. In an exemplary embodiment, the junction member 400 is formed using a double-faced adhesive high-polymer film. The junction member 400 adhere the electro-optic device 200 to the first plate 110 by the adhesive force thereof. Thereafter, a second plate 120 is adhered to the electro-optic device 200. In this case, the junction member 400 may be adhered to the rear surface of the second plate 120 at the location corresponding to the light emitting region of the first plate 110. Accordingly, the electro-optic device 200 is disposed between the first plate 110 and the second plate 120 that face each other. Thereafter, a coupling member 130 is installed in the edge region of the first and second plates 110 and 120 to fix the first and second plates 110 and 120. It is effective that the internal space of the multi-layered, i.e., the space between the first plate 110 and the second plate 120 is vacuum-processed.

In an exemplary embodiment, the first plate 110 is prepared, the first and second electrode interconnections 310 and 320 are formed on the rear surface of the first plate 110, and the electro-optic device 200 and the second plate 120 are joined together. The present invention is not limited thereto. For example, the second plate 120 may be prepared, the first and second electrode interconnections 310 and 320 may be formed on the second plate 120, and the electro-optic device 200 and the first plate 110 may be joined together. In an exemplary embodiment, the electro-optic device 200 is adhered to the junction member 400 after the first plate 110 is adhered to the junction member 400. However, the present invention is not limited thereto, and the electro-optic device 200, to which the junction member 400 was adhered, may be adhered to the first plate 110.

In this way, the electro-optic device 200 is installed into the internal space of the multi-layered member 100, thereby making it possible to easily manufacture a large-area display apparatus. Also, since the electro-optic device 200 is installed in the transparent multi-layered member 100, the display apparatus may be used as a lighting device. Also, the electro-optic device 200 is installed in various of multi-layered members 100 with an internal space, thus making it possible to prevent the damage of the electro-optic device 200 caused by an external physical impact.

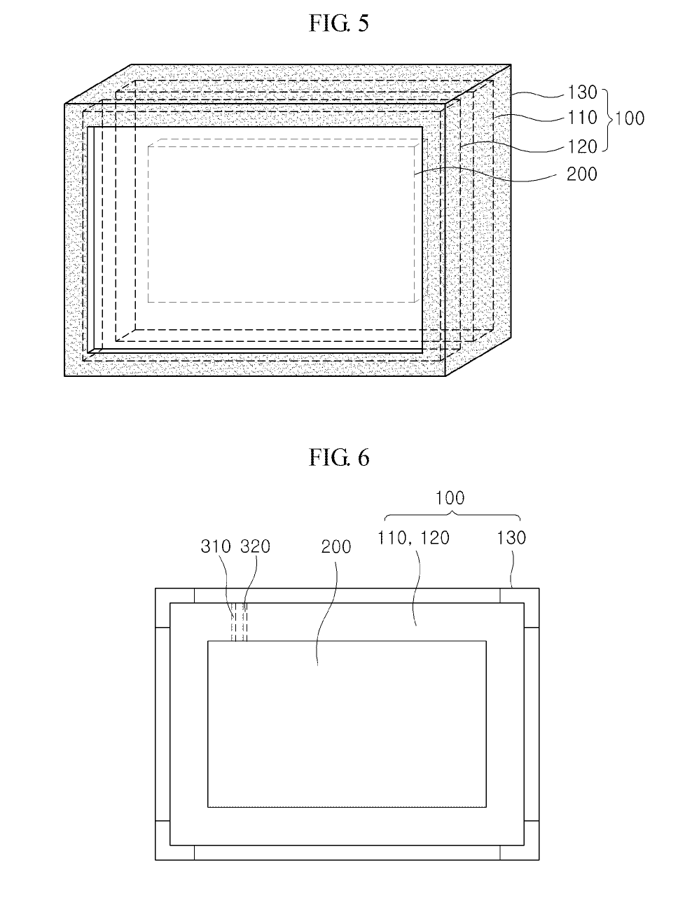

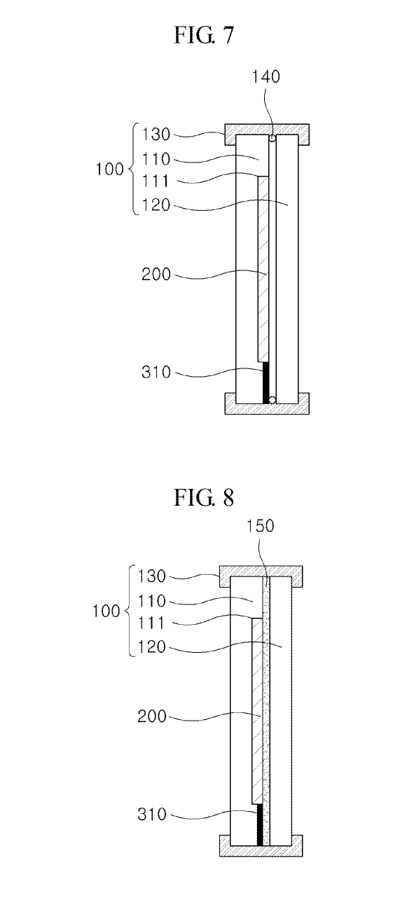

FIG. 5 is a perspective view of a display apparatus according to Embodiment 2. FIG. 6 is a plan view of a display apparatus according to Embodiment 2. FIG. 7 is a sectional view of a display apparatus according to Embodiment 2. FIG. 8 is a sectional view of a display apparatus according to a modification of Embodiment 1. A description of an overlap with Embodiment 1 will be omitted for conciseness.

A display apparatus according to Embodiment 2 includes an electro-optic device 200 installed into the internal space of a multi-layered member 100. As shown in FIGS. 5 through 7, the display apparatus includes a multi-layered member 100 with an internal space; an electro-optic device 200 installed into the internal space of the multi-layered member 100; and first and second electrode interconnections 310 and 320 disposed on the inner surface of the multi-layered member 100 to supply power to the electro-optic device 200.

The multi-layered member 100 includes: first and second plates 110 and 120 spaced apart from each other to face each other; a concave portion 111 disposed at the inside of one of the first and second plates 110 and 120 to install an electro-optic device 200 therein; and a coupling member 130 disposed in an edge region of the first and second plates 110 and 120 to fix the first and second plates 110 and 120. The multi-layered member 100 may be formed corresponding to the size of the display apparatus. In an exemplary embodiment, in order to manufacture a display apparatus used as a window device to be installed on the internal/external surface of a building, first and second plates 110 and 130 of the corresponding sizes are prepared. Also, a spacer 140 is disposed between the first plate 110 and the second plate 120 to space the first plate 110 and the second plate 120 apart from each other by a predetermined distance. In this way, the first and second plates 110 and 120 are disposed to face each other, thereby providing an internal space of the multi-layered member 100. The present invention is not limited thereto, and a transparent filling material 150 may be disposed between the first plate 110 and the second plate 120, as shown in FIG. 8. The transparent filling material 150 may include at least one of a solid transparent tape and a transparent organic material. The transparent organic material may include one of a photo-curable organic material and a thermo-curable organic material in a liquid phase. If a transparent organic material is used as the transparent filling material, a filling material formed of a transparent organic material is inserted between the first and second plates 110 and 120 and then the first and second plates 110 and 120 are hardened through a photo-curing process or a thermo-curing process. Accordingly, the first and second plates 110 and 120 can be closely adhered by the filling material 150. The present invention is not limited thereto, and the space between the first and second plates 110 and 120 may be vacuum-processed or may be filled with inactive gas.

The electro-optic device 200 is inserted into an inner space of the multi-layered member 100, i.e., a space between the first plate 110 and the second plate 120. Although one electro-optic device 200 is inserted in the present embodiment, the present invention is not limited thereto. For example, a plurality of electro-optic devices 200 may be inserted into the space between the first plate 100 and the second plate 120. Here, the concave portion 111 in which the electro-device 200 is inserted is defined in one of the first plate 110 and the second plate 120. In the present embodiment, the concave portion 111 for inserting the electro-optic device 200 is defined in the first plate 110. Here, the concave portion 111 may have a size and thickness corresponding to those of the electro-optic device 200 to fix the electro-optic device 200 therein without the movement of the electro-optic device 200, the present invention is not limited thereto. For example, the concave portion 111 may be defined in the second plate 120. Here, although not shown, a junction member (not shown) for fixing the electro-optic device 200 to the concave portion 111 may be disposed on an inner surface of the concave portion 111. The first and second plates 110 and 120 may be formed of transparent materials that may transmit light generated from the electro-optic device 200, respectively. Although the first and second plates 110 and 120 are formed of transparent glasses in the present embodiment, the present invention is not limited thereto. For example, the first and second plates 110 and 120 may be formed of transparent materials. Also, although the first and second plates 110 and 120 may be formed of the same material, the first and second plates 110 and 120 may be formed of materials different from each other. For example, only one of the first and second plates 110 and 120 may be formed of a transparent material. Although the first and second plates 110 and 120 have square shapes, the present invention is not limited thereto. For example, the first and second plates 110 and 120 may have various shapes. Here, the inner space of the multi-layered member 100, i.e., the space between the first plate 110 and the second plate 120 may be vacuum-treated, the present invention is not limited thereto. For example, the space between the first plate 110 and the second plate 120 may be filled with an inactive gas that does not contain oxygen O₂ or moisture, e.g., a nitrogen gas. As described above, as the electro-optic device 200 is disposed within the multi-layered member 100 including the first and second transparent plates 110 and 120, a separate encapsulation process may be omitted during the manufacturing process of the electro-optic device 200. That is, the first and second plates 110 and 120 may encapsulate the electro-optic device 200. Also, as the electro-optic device 200 is disposed between the first and second plates 110 and 120, it may prevent the electro-optic device 200 from being damaged by external physical impacts.

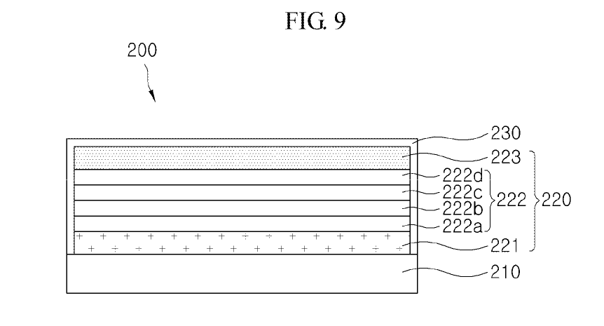

FIG. 9 is a sectional view illustrating an electro-optic device according to a second embodiment.

According to the embodiment, an organic light emitting device (OLED) is used as the electro-optic device 200. Here, a transparent organic light emitting device (TOLED) is manufactured. Therefore, the display device using TOLED can serve as lighting and display device once the TOLED is driven and can serve as a transparent windows system if the TOLED is not driven by using the transparency of the TOLED. Referring to FIG. 9, this electro-optic device 200 includes a substrate 210, an organic light emitting layer 220 formed on the substrate to emit light, and a protective layer 230 disposed to cover the organic light emitting layer 220. Here, the organic light emitting layer 220 includes a bottom electrode 221 formed on the substrate 210, an organic layer 222 formed on the bottom electrode 221, and a top electrode 223 formed on the organic layer 222.

The substrate 210 is manufacturing using transparent material in order to allow light generated from the organic layer 222 to penetrate the substrate 210 and then reach the outside. In an embodiment, glass or plastic is used as the substrate 210. A lower electrode used as an anode is formed on the substrate 210. Here, the lower electrode 221 is manufactured using a conductive material. That is, the lower electrode 221 is formed from one of Indium Tin Oxide (ITO), Indium Zinc Oxide (IZO), Zinc Oxide (ZnO) and In₂O₃.

The organic material layer 222 is formed on the lower electrode 221, and includes a hole injection layer 222a, a hole transfer layer 222b, a light emitting layer 222c, and a electron transfer layer 222d. Here, the organic material layer 222 may include the sequentially stacked hole injection layer 222a, hole transfer layer 222b, light emitting layer 222c, and electron transfer layer 222d.

The upper electrode 223 according to an embodiment serves as a cathode and is formed on the electron transfer layer 222d of the organic material layer 222. As mentioned above, according to an embodiment, the lower electrode 221 and the upper electrode 223 are transparent. For this, metal material such as LiF—Al, Mg:Ag, Ca—Ag is deposited less than several μm to form the upper electrode 223. Of course, embodiments are not limited thereto and thus the upper electrode 223 may be manufactured using a transparent conductive material such as ITO, IZO, ZnO and In₂O₃. This upper electrode 223 is deposited and formed on the organic material layer 222 through a sputtering process.

The protective layer 230 serves to protect the organic light emitting layer 222 on the substrate 210. The protective layer 230 may be formed from one of inorganic matter such as SiO2, SiNx, Al₂O₃, AION, AIN, MgO, Si₃N₄, and SiON. Here, the protective layer 230 may be formed with transparency. This protective layer 230 is formed to cover the organic light emitting layer 222 on the substrate 210 and prevents moisture and atmosphere from penetrating into the electro-optic device 200.

In an embodiment, the electro-optic device 200 has a rectangular section but is not limited thereto and thus may include diverse forms of sections. That is, the section of the electro-optic device 200 may be an image or a character that a user wants to display.

First and second electrode interconnections 310 and 320 serve to supply power to the electro-optic device 200. One ends of the first and second electrode interconnections 310 and 320 are connected to the electro-optic device 200, and other ends extend to the outside and then are installed such that they are connected to power of the external. Here, the first and second electrode interconnections 310 and 320 are formed at the bottom of at least one of the first and second plates 110 and 120. In an embodiment, the first and second electrode interconnections 310 and 320 are formed at the bottom of the first plate 110. Of course, this is not limited thereto, and thus the first and second electrode interconnections 310 and 320 may be formed at the bottom of the second plate 120 or may be formed at the first and second plates 110 and 120, respectively. These first and second electrode interconnections 310 and 320 are connected to the lower electrode 221 and upper electrode 223 of the electro optic device 200. Moreover, the first and second electrode interconnections 310 and 320 may be formed of one of transparent conductive materials such as ITO, IZO, ZnO and In₂O₃ through a sputtering process. According to an embodiment, the first and second electrode interconnections 310 and 320 are formed from a transparent conductive material but embodiments are not limited thereto and thus the first and second electrode interconnections 310 and 320 may be formed from metal with excellent electrical conductivity. Here, the transparent first and second electrode interconnections 310 and 320 may be formed by forming the metal of less than several μm.

Hereinafter, referring to FIGS. 5 through 8, a method of manufacturing a display device according to an embodiment will be briefly described.

First, a first plate 110 having a concave portion 111 at the bottom is prepared. The transparent first and second electrode interconnections 310 and 320 are formed on the bottom of the first plate 110. Here, the concave portion 111 has a size and thickness corresponding to the electro-optic device 200 and allows the electro-optic device 200 to be fixed at the concave portion 111. Here, the first and second electrode interconnections 310 and 320 may be formed to be electrically connected to the electro-optic device 200 that will be inserted and mounted in the concave portion 111 of the first plate 110. Here, the first and second electrode interconnections 310 and 320 are formed of transparent conductive materials such as ITO, IZO, ZnO and In₂O₃. In this embodiment, a transparent organic light emitting device is used as the electro-optic device 200. Then, the second plate 120 is disposed in a direction into which the electronic-optic device 300 is inserted. That is, the bottom of the first plate 110 into which the electro-optic device 200 is inserted and mounted is disposed to be spaced from and facing the bottom of the second plate 120. By disposing a spacer 140 between the first and second plates 110 and 120, the first plate 110 is spaced a predetermined distance apart from the second plate 120. Thereby, the electro-optic device 200 is inserted and mounted in the double layered member 100. Next, a coupling member 130 is mounted on the edge regions of the first and second plates 110 and 120 to fix the first and second plates 110 and 120. The inside space of the double layered type member 100 is effected when vacuum process is performed. Additionally, according to an embodiment, the electro-optic device 200 is inserted and mounted in the inside space of the multi-layered member 100 and thus additional encapsulation process is not performed on the electro-optic device 200.

According to the embodiment, the concave portion 111 is disposed in the first plate 110 and the electro-optic device 200 is inserted and mounted in the concave portion 111. However, embodiments are not limited thereto such that the concave portion 111 is prepared in the second plate 120 and the electro-optic device 200 may be inserted and mounted in the concave portion 111. As mentioned above, although the first and second electrode interconnections 310 and 320 are formed in the first plate 110, embodiments are not limited thereto and thus the first and second electrode interconnections 310 and 320 may be formed on the second plate 120 or the first and second electrode interconnections 310 and 320 may be formed separately on the first and second plates 110 and 120 respectively.

As mentioned above, according to the second embodiment, by inserting and mounting the electro-optic device 200 (i.e., transparent organic light emitting device) in the multi-layered member 100, the display devices may function as windows device or lighting, and displaying devices. That is, if the electro-optic device 200 is not driven, it serves as a windows system but if the electrode-optic device 200 is driven, it serves as a lighting and display device. Here, the first and second plates 110 and 120 of the multi-layered member may be manufactured in correspondence to a size of a display device to be manufactured. Accordingly, by inserting and mounting a small-sized electro-optic device in an inner space of the multi-layered member with a large area, a display of a large area can be manufactured without using a large sized deposition device and a large-sized substrate. Moreover, the multi-layered member 100 may serve as a glass window with insulation and sound proof effect as the first and second plates 110 and 120 are spaced to face each other. Moreover, since the electro-optic device 200 is mounted in the multi-layered member 100 having an inner space, an additional encapsulation process is not required such that simple manufacturing processes can be achieved. By using the multi-layered member 100, it prevents the electro-optic device from being damaged by external physical impact.

As described above, in exemplary embodiments, an electro-optic device is inserted and mounted into the internal space of the multi-layered member. Herein, the multi-layered member includes the first and second plates disposed to be separated from each other and facing each other. At least one of the first and second plates is manufactured with a transparent material to transmit light that is generated from the electro-optic device. Among the first and second plates of the multi-layered member, a plate corresponding to the size of a display apparatus to be manufactured is used. Consequently, by inserting and mounting a small electro-optic device into the internal space of the multi-layered member that is manufactured in a large area, a large-area display apparatus can be manufactured even without using a large-size deposition apparatus and a large-area substrate. Accordingly, the manufacturing cost of the large-area display apparatus can be saved. Furthermore, the electro-optic device is disposed in the internal space of the multi-layered member including the first and second plates, and thus the display apparatus can prevent the electro-optic device from being damaged by an external physical impact.

According to exemplary embodiments, moreover, the first and second plates of the multi-layered member are manufactured with a light-transmitting material, and a transparent electro-optic device is inserted and mounted into the internal space of the multi-layered member including the first and second plates. Consequently, the electro-optic device serves as a display apparatus when being driven, and it serves as a transparent window when not being driven.

Although the display apparatus and the method for manufacturing the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A display device comprising:
first and second plates spaced apart from and facing each other;
a coupling member around edges of the first and second plates, the coupling member configured to fix the first and second plates; and
an electro-optic device having one side on an inner side of one of the first and second plates between the first and second plates and another side on an inner side of the other of the first and second plates.

2. A display device comprising:
first and second plates spaced apart from and facing each other;
a concave portion in an inner side of one of the first and second plates;
a coupling member around edges of the first and second plates to fix the first and second plates; and
an electro-optic device in the concave portion.

3. The display device of claim 1, further comprising one or more of a transparent filling material, vacuum, and an inactive gas between the first and second plates, wherein the transparent filling material comprises at least one of a transparent tape and a transparent organic material.

4. The display device of claim 2, further comprising one or more of a transparent filling material, vacuum, and an inactive gas between the first and second plates, wherein the transparent filling material comprises at least one of a transparent tape and a transparent organic material.

5. The display device of claim 1, further comprising an electrode interconnection on the inner side of at least one of the first and second plates to supply power to the electro-optic device.

6. The display device of claim 2, further comprising an electrode interconnection on the inner side of at least one of the first and second plates to supply power to the electro-optic device.

7. The display device of claim 5, wherein the electrode interconnection comprises a transparent conductive material.

8. The display device of claim 6, wherein the electrode interconnection comprises a transparent conductive material.

9. The display device of claim 1, wherein at least one of the first and second plates comprises a transparent material, and the transparent material is disposed in a light-emitting direction, the light being emitted from the electro-optic device.

10. The display device of claim 2, wherein at least one of the first and second plates comprises a transparent material, and the transparent material is disposed in a light-emitting direction, the light being emitted from the electro-optic device.

11. The display device of claim 1, wherein the electro-optic device includes an organic light emitting device (OLED).

12. The display device of claim 2, wherein the electro-optic device includes an organic light emitting device (OLED).

13. The display device of claim 2, further comprising a spacer spacing the first and second plates by a predetermined distance in a region between the first and second plates, in a location other than that of the electro-optic device.

14. A method of manufacturing a display device, the method comprising:
disposing first and second plates to be spaced apart from each other; and
attaching one side of an electro-optic device to an inner side of one of the first and second plates, and attaching another side of the electro-optic device to an inner side of the other one of the first and second plates.

15. A method of manufacturing a display device, the method comprising:
preparing first and second plates and a concave portion in an inner side of one of the first and second plates;
mounting an electro-optic device in the concave portion; and
spacing the other one of the first and second plates to face the one plate where the electro-optic device is mounted.

16. The method of claim 14, further comprising filling a space between the first and second plates with at least one of a transparent filling material, vacuum, and an inactive gas.

17. The method of claim 15, further comprising filling a space between the first and second plates with at least one of a transparent filling material, vacuum, and an inactive gas between the first and second plates.

18. The method of claim 14, further comprising forming an electrode interconnection on the inner side of at least one of the first and second plates, the electrode interconnection supplying power to the electro-optic device.

19. The method of claim 15, further comprising forming an electrode interconnection on an inner side of at least one of the first and second plates, the electrode interconnection supplying power to the electro-optic device.

20. The method of claim 15, further comprising mounting a spacer between the first and second plates in a location other than that of the electro-optic device, the spacer spacing the first and second plates by a predetermined distance.
